(19) United States
(12) Patent Application Publication
(10) Pub. No.: US 2025/0382458 A1
(43) Pub. Date: Dec. 18, 2025

(54) POLYMER BLEND CABLE JACKET

(71) Applicants: DAIKIN AMERICA, INC., Orangeburg, NY (US); DAIKIN INDUSTRIES, LTD., Osaka-shi (JP)

(72) Inventors: Yuki Kuwajima, Decatur, AL (US); Wade Martin Simpson, Decatur, AL (US)

(73) Assignees: DAIKIN AMERICA, INC., Orangeburg, NY (US); DAIKIN INDUSTRIES, LTD., Osaka-shi (JP)

(21) Appl. No.: 19/234,954

(22) Filed: Jun. 11, 2025

Related U.S. Application Data
(60) Provisional application No. 63/659,021, filed on Jun. 12, 2024.

(51) Int. Cl. C08L 77/02; C08J 3/22; C08L 33/10; H01B 3/30; H01B 13/14

(52) U.S. Cl. CPC C08L 77/02; C08J 3/226; C08L 33/10; H01B 3/305; H01B 13/14; C08J 2377/02; C08J 2423/06; C08J 2427/18; C08J 2433/10; C08L 2203/202; C08L 2205/035; C08L 2207/068; C08L 2310/00

(57) ABSTRACT

Polymer blends are described for various uses, including in cable jackets and cable conduits. The blends contain a low fluorine (or fluorine-free) resin, such as a polyamide (PA). The resin is blended with one or both of an acrylic polymer and a polyethylene polymer at concentrations effective to produce an article with low surface friction. The polymer blend can be produced using a master batch containing more highly concentrated acrylic polymer and/or polyethylene polymer, that can then be diluted in the resin. Small amounts of fluoropolymer may be added in some formulations to further reduce surface friction.

### CROSS-REFERENCE TO RELATED APPLICATIONS

This application claims the benefit of U.S. Provisional Patent Application No. 63/659,021, filed Jun. 12, 2024, which is incorporated herein by reference in its entirety.

### BACKGROUND

### Field of the Disclosure

The present disclosure relates generally to polymer materials useful as jacketing for cables, as well as methods of making and using the same.

### Background

When cables are installed in a building, they are often pulled through a conduit. Reducing the amount of force needed to pull a length of cable is desirable, because it both reduces the energy needed to install the cable and reduces the likelihood that the cable will be damaged during installation. Keeping the pull force low has the advantage of reducing impact on the electrical properties of the cable. The use of excessive pulling force can deform the conductor (usually copper), thereby changing the electrical properties of the cable. The force required to pull the cable through a conduit can be reduced by providing a low-friction jacket on the cable.

Fluorine compounds (such as fluoropolymers) have very low friction, but have certain limitations as well. Fluorine-containing polymers tend to be expensive and are manufactured in small amounts compared to some other polymer products, creating availability issues. Many fluorine-containing polymers also have relatively weak mechanical properties.

Friction can also be reduced through the use of lubricant. This again increases the cost of installation. In addition, lubricants can interact with the cable jacket and surrounding conduit in ways that degrade their properties. Some lubricants are conductive, which can complicate their use with conductive cables.

Accordingly, there remains a need in the art for cable jacketing materials that are low-friction without the drawbacks of current technology described above.

### SUMMARY

The problems expounded above, as well as others, are addressed by the following inventions, although it is to be understood that not every embodiment of the inventions described herein will address each of the problems described above. The present disclosure provides cable jacketing materials composed of a blend of a polymethyl acrylate and a polyamide. The resulting jacket is very low friction and has good thermomechanical properties.

A first general embodiment is a cable having a jacket, the jacket comprising a low-friction polymer blend of a polyamide (PA) and one or both of a polymethyl acrylate (PMA) and a polyethylene (PE).

A second general embodiment is a masterbatch polymer blend, comprising: a PA; and 20-80% w/w of a PMA, a PE, or a combination of both.

A third general embodiment is a method of making a low-friction polymer blend, the method comprising: diluting with additional PA a masterbatch polymer blend comprising PA and one or both of a PMA and a PE, resulting in the low-friction polymer blend having up to about 10% w/w of the one or both of PMA and PE.

A fourth general embodiment is a low-friction polymer blend that is the product of a method comprising: diluting a masterbatch polymer blend comprising PA and one or both of PMA and PE with additional PA, resulting in the low-friction polymer blend having up to about 10% w/w of the one or both of PMA and PE.

A fifth general embodiment is a method of making a low-friction polymer blend, the method comprising: blending a PA and with one or both of a PMA and PE, resulting in the low-friction polymer blend having up to about 10% w/w of the one or both of PMA and PE.

A sixth general embodiment is a low-friction polymer blend that is the product of a method comprising: blending a PA with one or both of a PMA and a PE, resulting in the low-friction polymer blend having up to about 10% w/w of the one or both of PMA and PE.

A seventh general embodiment is a low-friction polymer blend comprising: a PA; and one or both of a PMA and a PE.

An eighth general embodiment is a cable having a jacket, wherein the jacket comprises the low-friction polymer blend of the fourth, sixth, or seventh general embodiments.

A ninth general embodiment is a method of manufacturing a cable, comprising: extruding a polymer melt comprising PA and one or both of a PMA and a PE to form an outer jacket of said cable.

A tenth general embodiment is a method of manufacturing a cable, comprising: diluting the masterbatch polymer blend of the second general embodiment with additional PA to form a polymer melt having up to about 10% w/w of the polymethyl acrylate (PMA), polyethylene (PE), or combination of both; and extruding the polymer melt to form an outer jacket of a cable.

An eleventh general embodiment is a conduit for a cable comprising an inner surface comprising the low-friction polymer blend of the fourth, sixth, or seventh general embodiments.

The above presents a simplified summary in order to provide a basic understanding of some aspects of the claimed subject matter. This summary is not an extensive overview. It is not intended to identify key or critical elements or to delineate the scope of the claimed subject matter. Its sole purpose is to present some concepts in a simplified form as a prelude to the more detailed description that is presented later.

### BRIEF DESCRIPTION OF THE DRAWINGS

FIG. 1A-FIG. 1C: Photographs of the apparatus used to test pull force requirements. FIG. 1A shows an example of the pull force test apparatus in position in a testing machine (Instron 5582—Instron, Norwood, MA). FIG. 1B shows detail of the exemplar pull force apparatus. FIG. 1C shows the pull force test apparatus in position in a testing machine with a strand inserted for testing.

FIG. 2: A schematic process for making polymer blend pellets.

FIG. 3: The results of pull-force tests on embodiments of the polymer blend containing ultra-high molecular weight polyethylene (UHMWPE) and PTFE. Sample 1 is a comparative example containing PA6 without UHMWPE.

FIG. 4: The results of pull-force tests on embodiments of the polymer blend containing cross-linked polymethyl acrylate (x-PMA) with and without PTFE. Sample 1 is a comparative example containing PA6 without x-PMA.

FIG. 5: An embodiment of the cable 10 showing jacket 100, shielding 200, and conductors 300 surrounded by insulation 400.

### DETAILED DESCRIPTION

### Definitions

Unless otherwise defined, all terms (including technical and scientific terms) used herein have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly so defined herein. Well known functions or constructions may not be described in detail for brevity or clarity.

The terminology used herein is for the purpose of describing particular embodiments only and is not intended to be limiting. As used herein, the singular forms “a”, “an” and “the” are intended to include the plural forms as well (i.e. “at least one”), unless the context clearly indicates otherwise. The term “may” as used herein refers to features that are optional (i.e., “may or may not,”), and should not be construed to limit what is described.

The terms “about” and “approximately” shall generally mean an acceptable degree of error or variation for the quantity measured given the nature or precision of the measurements. Typical, exemplary degrees of error or variation are within 20 percent (%), preferably within 10%, more preferably within 5%, and still more preferably within 1% of a given value or range of values. Numerical quantities given in this description are approximate unless stated otherwise, meaning that the term “about” or “approximately” can be inferred when not expressly stated.

With reference to the use of the word(s) “comprise,” “comprises,” and “comprising” in the foregoing description and/or in the following claims, unless the context requires otherwise, those words are used on the basis and clear understanding that they are to be interpreted inclusively, rather than exclusively, and that each of those words is to be so interpreted in construing the foregoing description and/or the following claims.

The term “including” should be interpreted to mean “including but not limited to . . . ” unless the context clearly indicate otherwise.

The term “consisting essentially of” means that, in addition to the recited elements, what is claimed may also contain other elements (steps, structures, ingredients, components, etc.) that do not adversely affect the operability of what is claimed for its intended purpose. Such addition of other elements that do not adversely affect the operability of what is claimed for its intended purpose would not constitute a material change in the basic and novel characteristics of what is claimed

The terms “first,” “second,” and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

Terms such as “at least one of A and B” should be understood to mean “only A, only B, or both A and B.” The same construction should be applied to longer list (e.g., “at least one of A, B, and C”).

This description may refer to published standards to measure certain properties of what is described. In the absence of an explicit reference to an edition or revision of the standard, it should be assumed that the edition or revision of the standard is the one most recently preceding the filing date of this application.

It is to be understood that any given elements of the disclosed embodiments of the invention may be embodied in a single structure, a single step, a single substance, or the like. Similarly, a given element of the disclosed embodiment may be embodied in multiple structures, steps, substances, or the like. None of the definitions above are intended to define what might be considered “equivalent” to anything that is claimed, under the “doctrine of equivalents” or analogous laws.

### Masterbatch and Method of Making

A masterbatch polymer blend (also interchangeably referred to as “masterbatch” throughout this disclosure) is provided, comprising a fluorine-free resin. In some embodiments, the masterbatch polymer blend additionally comprises an acrylic polymer, a polyethylene polymer (different from the fluorine-free resin), or combinations thereof. Embodiments of the masterbatch blend may find use in preparing a low-friction polymer blend, as described further below.

Any fluorine-free resin not inconsistent with the technical objectives of this disclosure may be employed in a masterbatch described herein. The fluorine-free resin will preferably have thermal, mechanical, and electrical properties suitable for use in a cable jacket 100 or a low-friction conduit. In some embodiments, the fluorine-free resin comprises one or more polyamide resins, polyolefin resins, or combinations thereof. In some embodiments, the fluorine-free resin is a polyamide resin. Exemplary polyamide resins suitable for a masterbatch herein include polyamide 6 (polycaprolactam or “PA-6”), polyamide 66, polyamide 12, or combinations thereof. In a preferred embodiment the fluorine-free resin is polyamide 6.

Any acrylic polymer not inconsistent with the technical objectives of this disclosure may be employed in the masterbatch. The acrylic polymer will preferably reduce the frictional characteristics of the final blend. Examples of suitable acrylic polymers for use in the masterbatch herein include polyacrylic and polymethacrylic materials, such as polymethyl acrylate (PMA) and polymethyl methacrylate (PMMA). In some embodiments, the acrylic polymer is a cross-linked acrylic polymer. In a preferred embodiment, the acrylic polymer is a cross-linked polymethyl acrylate (X-PMA).

In some embodiments, the acrylic polymer has an average particle size of up to about 20 μm, 15 μm, 10 μm, 9 μm, 8 μm, 7 μm, 6 μm, 5 μm, 4 μm, 3 μm, 2 μm, or 1 μm. In some embodiments, the acrylic polymer has an average particle size of up to about 20, 19, 18, 17, 16, 15, 14, 13, 12, 11, 10, 9, 8, 7, 6, 5.9 μm, 5.8 μm, 5.7 μm, 5.6 μm, 5.5 μm, 5.4 μm, 5.3 μm, 5.2 μm, 5.1 μm, 4.9 μm, 4.8 μm, 4.7 μm, 4.6 μm, 4.5 μm, 4.4 μm, 4.3 μm, 4.2 μm, 4.1 μm, 4.0 μm, 3.9 μm, 3.8 μm, 3.7 μm, 3.6 μm, 3.5 μm, 3.4 μm, 3.3 μm, 3.2 μm, 3.1 μm, or 3.0 μm. In some embodiments, the acrylic polymer has an average particle size of about 1 to about 20 μm, about 2 to about 8 μm, about 3 to about 8 μm, about 4 to about 8 μm, about 2 to about 7 μm, about 3 to about 7 μm, about 4 to about 7 μm, about 2 to about 6 μm, about 3 to about 6 μm, about 4 to about 6 μm, about 4.2 to about 5.4 μm, about 4.3 to about 5.3 μm, about 4.4 to about 5.2 μm, about 4.5 to about 5.1 μm, about 4.6 to about 5.0 μm, or about 4.7 to about 4.9 μm. The average particle size may be measured as the value corresponding to 50% of the cumulative particle size distribution obtained using a laser diffraction particle size analyzer.

The acrylic polymer may have any properties not inconsistent with the technical objectives herein. For instance, in some embodiments, the acrylic polymer has a decomposition temperature of up to about 275° C., 270° C., 265° C., 260° C., 255° C., or 250° C. In some embodiments, the acrylic polymer has a decomposition temperature of about 180° C.-275° C., 200° C.-275° C., 220° C.-275° C., 225° C.-275° C., 230° C.-275° C., 235° C.-275° C., 180° C.-260° C., 200° C.-260° C., 220° C.-260° C., 225° C.-260° C., 230° C.-260° C., or 235° C.-260° C. The decomposition temperature may be determined or measured by ASTM E-1641-18 (2018).

In some embodiments, the acrylic polymer has a heating loss of less than about 0.9, 0.8, 0.7, 0.6, 0.5, 0.4, 0.3 or 0.2% w/w.

Any polyethylene polymer not inconsistent with the technical objectives of this disclosure may be employed in a masterbatch described herein. The polyethylene will preferably reduce the frictional characteristics of the final blend. Suitable polyethylene polymers include ultra-high molecular weight polyethylene (UHMWPE), high-density polyethylene (HDPE), medium-density polyethylene (MDPE), low-density polyethylene (LDPE), linear low-density polyethylene (L-LDPE), and very low-density polyethylene (V-LDPE). A preferred embodiment of the masterbatch contains UHMWPE.

In some embodiments, a masterbatch described herein includes at least about 10%, 20%, 30%, 40%, 50%, 60%, 70%, or 80% w/w acrylic polymer, polyethylene polymer, or combinations thereof. In some embodiments, the masterbatch comprises up to about 95%, 90%, 85%, 80%, 75%, 70%, 65%, 60%, 55%, or 50% w/w acrylic polymer, polyethylene polymer, or combinations thereof. In some embodiments herein, the masterbatch comprises about 10%-95%, 10-90%, 10-85%, 10-80%, 10-75%, 10-70%, 10-65%, 10-60%, 10-55%, 10-50%, 20%-95%, 20-90%, 20-85%, 20-80%, 20-75%, 20-70%, 20-65%, 20-60%, 20-55%, 20-50%, 30%-95%, 30-90%, 30-85%, 30-80%, 30-75%, 30-70%, 30-65%, 30-60%, 30-55%, 30-50%, 40%-95%, 40-90%, 40-85%, 40-80%, 40-75%, 40-70%, 40-65%, 40-60%, 40-55%, 40-50%, 50%-95%, 50-90%, 50-85%, 50-80%, 50-75%, 50-70%, 50-65%, 50-60%, or 50-55% w/w acrylic polymer, polyethylene polymer, or combinations thereof. In a preferred embodiment, the acrylic polymer, polyethylene, or combination thereof is present at about 20% w/w to about 80% w/w in the masterbatch.

A masterbatch described herein may also optionally comprise a fluoropolymer. Examples thereof include polytetrafluoroethylene (PTFE), tetrafluoroethylene (TFE)/perfluoro (alkyl vinyl ether) (PAVE) copolymers (PFA), TFE/hexafluoropropylene (HFP) copolymers (FEP), ethylene (Et)/TFE copolymers (ETFE), Et/TFE/HFP copolymers (EFEP), and polyvinylidene fluoride (PVdF). In a preferred embodiment, the fluoropolymer is PTFE. In some embodiments, the masterbatch comprises up to about 80%, 75%, 70%, 65%, 60%, 55%, 50%, 45%, 40%, 35%, 30%, 25%, 20%, 19%, 18%, 17%, 16%, 15%, 14%, 13%, 12%, 11%, 10%, 9%, 8%, 7%, 6%, 5%, 4%, 3%, 2%, 1%, or 0.5% w/w of the fluoropolymer. It is to be understood that the presence or addition of a fluoropolymer is optional, and the masterbatch may comprise 0% fluoropolymer, or may comprise an insignificant amount of fluoropolymer. Fluoropolymers have the advantage of very low surface friction.

The masterbatch may also contain additional optional components as appropriate. Examples of additional components include additives such as crosslinkers, crosslinking aids, antistatics, heat-resistance stabilizers, foaming agents, foam nucleating agents, antioxidants, surfactants, photo-polymerization initiators, abrasion inhibitors, surface modifiers, lubricants, processing aids, ultraviolet stabilizers, flame retardants, plasticizers, fillers, photostabilizers, reinforcing agents, impact-resistance improvers, and pigments.

The masterbatch may be produced by mixing the fluorine-free resin and the acrylic polymer and/or polyethylene polymer (or combination thereof) together, optionally with any additional components as appropriate. Mixing may be performed using any suitable device such as a single-or twin-screw extruder, an open roll mill, a kneader, or a Banbury mixer.

The masterbatch may be in any form not inconsistent with the technical objectives herein, such as, for example, a powder, granules, or pellets. In some embodiments, the masterbatch is in the form of pellets obtained by melt kneading. The temperature for the melt kneading, in some embodiments, is higher than the melting point of the fluorine-free resin by at least 5° C.

### Low-Friction Polymer Blend and Method of Making

A low-friction polymer blend is also provided, comprising a fluorine-free resin. In some embodiments, the low-friction polymer blend additionally comprises an acrylic polymer, a polyethylene polymer, or combinations thereof. Embodiments of the low-friction polymer blend may find use in cable jackets as described further below, and/or in methods of manufacturing the same.

Any fluorine-free resin not inconsistent with the technical objectives of this disclosure may be employed in the low-friction polymer blend described herein. The fluorine-free resin will preferably have thermal, mechanical, and electrical properties suitable for use in a cable jacket 100 or a low-friction conduit. In some embodiments, the fluorine-free resin comprises one or more polyamide resins, polyolefin resins, polyvinyl chloride resins, or combinations thereof. Any polyamide resin, polyolefin resin, and/or polyvinyl chloride resin described elsewhere in this disclosure, such as in the previous section (i.e., “Masterbatch and Method of Making”) may be employed in the low-friction polymer blends herein, such as, for example, polyamide 6, polyamide 66, polyamide 12, or combinations thereof. In a preferred embodiment, the fluorine-free resin is polyamide 6.

Any acrylic polymer not inconsistent with the technical objectives of this disclosure may be employed in the low-friction polymer blend herein. The acrylic polymer will preferably reduce the frictional characteristics of the final blend. Any acrylic polymers described elsewhere in this disclosure, such as in the previous section, may be employed, including polyacrylic and polymethacrylic materials, such as polymethyl acrylate (PMA) and polymethyl methacrylate (PMMA). In some embodiments, the acrylic polymer is a cross-linked acrylic polymer. In a preferred embodiment, the acrylic polymer is a cross-linked polymethyl acrylate (X-PMA).

The acrylic polymer in the low-friction polymer blend herein may have any properties and/or characteristics described elsewhere in this disclosure, including the previously disclosed average particle sizes and size ranges, decomposition temperatures, and/or heating loss properties. In some embodiments, a polymer blend described herein comprises up to about 15%, 14%, 13%, 12%, 11%, 10%, 9%, 8%, 7%, 6%, 5%, 4%, 3%, 2%, or 1% w/w of the acrylic polymer. In some embodiments, the polymer blend comprises at least about 0.05%, 0.1%, 0.2%, 0.3%, 0.4%, 0.5%, 0.75%, 1.0%, 1.25%, 1.5%, 1.75%, or 2.0% w/w of the acrylic polymer. In some embodiments, the polymer blend comprises about 0.1-15%, 0.1-10%, 0.1-9%, 0.1-8%, 0.1-7%, 0.1-6%, 0.1-5%, 0.1-4%, 0.1-3%, 0.1-2%, 0.1-1%, 0.5-15%, 0.5-10%, 0.5-9%, 0.5-8%, 0.5-7%, 0.5-6%, 0.5-5%, 0.5-4%, 0.5-3%, 0.5-2%, 0.5-1%, 1-15%, 1-10%, 1-9%, 1-8%, 1-7%, 1-6%, 1-5%, 1-4%, 1-3%, or 1-2% w/w of the acrylic polymer.

Any polyethylene polymer not inconsistent with the technical objectives of this disclosure may be employed in the low-friction polymer blend described herein. The polyethylene will preferably reduce the frictional characteristics of the final blend. For instance, the polyethylene polymers described elsewhere in this disclosure, such as in the preceding section, may be employed, including ultra-high molecular weight polyethylene (UHMWPE), high-density polyethylene (HDPE), medium-density polyethylene (MDPE), low-density polyethylene (LDPE), linear low-density polyethylene (L-LDPE), and very low-density polyethylene (V-LDPE). A preferred embodiment of the low-friction polymer blend herein contains UHMWPE.

In some embodiments, a low-friction polymer blend as described herein may also optionally comprise a fluoropolymer, such as any of the fluoropolymers described elsewhere in this disclosure, including polytetrafluoroethylene (PTFE), tetrafluoroethylene (TFE)/perfluoro (alkyl vinyl ether) (PAVE) copolymers (PFA), TFE/hexafluoropropylene (HFP) copolymers (FEP), ethylene (Et)/TFE copolymers (ETFE), Et/TFE/HFP copolymers (EFEP), and polyvinylidene fluoride (PVdF). In a preferred embodiment, the fluoropolymer is PTFE. In some embodiments, the low-friction polymer blend comprises up to about 80%, 75%, 70%, 65%, 60%, 55%, 45%, 40%, 35%, 30%, 25%, 20%, 19%, 17%, 16%, 15%, 14%, 14%, 12%, 11%, 10%, 9%, 8%, 7%, 6%, 5%, 4%, 3%, 2%, 1%, or 0.5% w/w fluoropolymer. It is to be understood that the presence or addition of a fluoropolymer is optional, and the polymer blend may comprise 0% fluoropolymer, or may comprise an insignificant amount of fluoropolymer.

The polymer blend may also contain additional optional components as appropriate. Any of the additional components disclosed hereinabove, or elsewhere in this disclosure, may be employed.

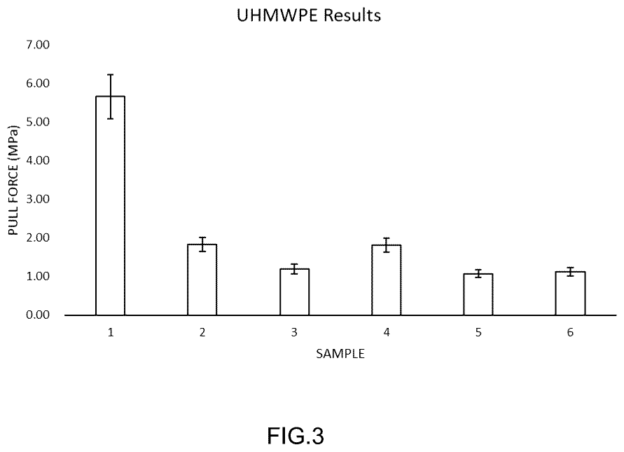

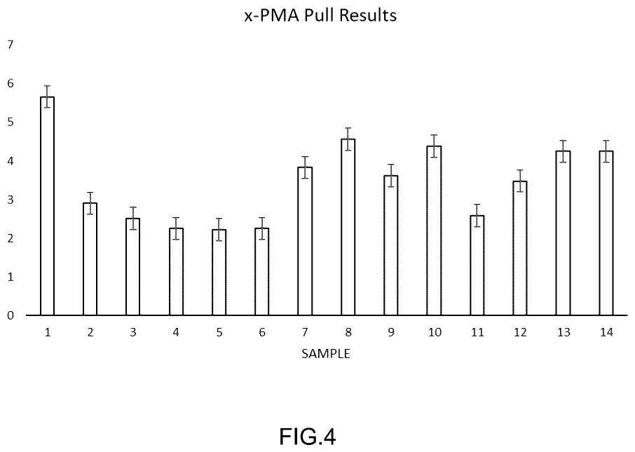

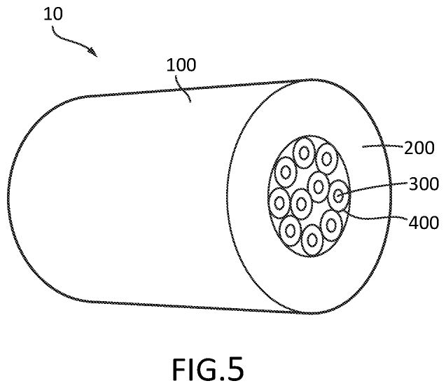

Preferred embodiments of the low-friction polymer blend confer low pull force requirements to articles made thereof. Results of pull force testing of some embodiments of the low-friction polymer blend and comparative examples are shown in FIGS. 3 and 4. Some preferred embodiments of the low-friction polymer blend display pull force requirements of no more than about 5.0, 4.9, 4.8, 4.7, 4.6, 4.5, 4.4, 4.3, 4.2, 4.1, 4.0, 3.9, 3.8, 3.7, 3.6, 3.5, 3.4, 3.3, 3.2, 3.1, 3.0, 2.9, 2.8, 2.7, 2.6, 2.5, 2.4, 2.3, 2.2, 2.1, 2.0, 1.9, 1.8, 1.7, 1.6, 1.5, 1.4, 1.3, 1.2, and 1.0 MPa. Pull force requirements in this context refer to the observed pull force according to the method in Example 1 below.

In some embodiments, a low-friction polymer blend described herein may be manufactured by a method comprising blending a fluorine-free resin with an acrylic polymer, a polyethylene polymer, or combinations thereof. Any fluorine-free resin, acrylic polymer, and/or polyethylene polymer disclosed elsewhere in this disclosure may be employed.

In some embodiments, the method comprises blending a fluorine-free resin with an acrylic polymer so as to achieve a polymer blend having a desired concentration of acrylic polymer. In some embodiments, the fluorine-free resin and the acrylic polymer are blended until the acrylic polymer concentration in the resulting polymer blend is about 0.1%-20% w/w. In some embodiments, the fluorine-free resin and the acrylic polymer are blended until the acrylic polymer concentration is about 0.1%-19%, 0.1-18%, 0.1-17%, 0.1-16%, 0.1-15%, 0.1-14%, 0.1-13%, 0.1-12%, 0.1-11%, or 0.1-10% w/w. In further embodiments, the fluorine-free resin and the acrylic polymer are blended until the acrylic polymer concentration is at least about 0.5%, 1.0%, 1.5%, 2.0%, or 2.5%.

In some embodiments, a low-friction polymer blend described herein may be manufactured by a method comprising mixing a masterbatch with an acrylic polymer so as to achieve a polymer blend having the desired concentration of acrylic polymer. In some embodiments, mixing the masterbatch with an acrylic polymer comprises diluting the masterbatch down in or with an acrylic polymer diluent so as to achieve a diluted composition (i.e., a low-friction polymer blend) having the desired concentration of acrylic polymer. In some embodiments, a masterbatch is diluted with an acrylic polymer to form a low-friction polymer blend having up to about 20%, 19%, 18%, 17%, 16%, 15%, 14%, 13%, 12%, 11%, or 10% w/w of the acrylic polymer. In some embodiments, the masterbatch polymer blend is diluted to the point at which the acrylic polymer concentration is about 0.1%-20%, 0.1%-19%, 0.1-18%, 0.1-17%, 0.1-16%, 0.1-15%, 0.1-14%, 0.1-13%, 0.1-12%, 0.1-11%, or 0.1-10% w/w. In further embodiments, the masterbatch polymer blend is diluted until the acrylic polymer concentration is at least about 0.5%, 1.0%, 1.5%, 2.0%, or 2.5%.

The masterbatch used in the method of manufacturing a polymer blend herein may have the compositions, characteristics, and/or properties described elsewhere in this disclosure, such as, for example, in the preceding section. For instance, in some embodiments, the masterbatch comprises a fluorine-free resin and additionally comprises an acrylic polymer, a polyethylene polymer, or combinations thereof. The masterbatch polymer blend may comprise any fluorine-free resin, acrylic polymer, and/or polyethylene polymer disclosed elsewhere in this disclosure. The additional acrylic polymer added to the masterbatch polymer blend (to dilute the masterbatch polymer blend with an additional acrylic polymer) may be any acrylic polymer described elsewhere in this disclosure. In some embodiments, the acrylic polymer is polymethyl acrylate (PMA). In some embodiments, the acrylic polymer is cross-linked polymethyl acrylate (X-PMA). Any masterbatch polymer blend disclosed elsewhere in this disclosure, including those disclosed in the section “Masterbatch and Method of Making” hereinabove, may be employed as the masterbatch used in the methods of manufacturing a polymer blend described herein. The masterbatch may contain the acrylic polymer, polyethylene polymer, or combination thereof in any of the amounts and concentrations disclosed in the preceding section or elsewhere in this disclosure. In a preferred embodiment, the acrylic polymer, polyethylene, or combination thereof is present at about 20% w/w to about 80% w/w in the masterbatch.

Additionally, the masterbatch may contain additional optional components as appropriate, such as any of the additional components described elsewhere in this disclosure. The masterbatch may be produced by mixing the fluorine-free resin and the acrylic polymer and/or polyethylene polymer together, optionally with any additional components as appropriate. Mixing may be performed using a device such as a single- or twin-screw extruder, an open roll mill, a kneader, a melt kneader, or a Banbury mixer.

The masterbatch may be in any form not inconsistent with the technical objectives herein, such as, for example, a powder, granules, or pellets. In some embodiments, the masterbatch is in the form of pellets obtained by melt kneading. The temperature for the melt kneading, in some embodiments, higher than the melting point of the fluorine-free resin by at least 5° C.

### Cable, Cable Jacket, Cable Conduit and Method of Making

In another aspect, a cable 10 is provided having good surface smoothness and workability for insertion into (or removal from) an article, such as a pipe or a conduit. Some embodiments of the cable 10 are less likely to suffer bleeding of components from a coating layer thereof, and thus also have excellent storage stability. Such reduced bleeding of components can reduce other problems, such as impairment of tactile sensations of the coating layer (stickiness on the surface) and sticking of such components to electric-wire-forming devices.

The cable 10 comprises a low-friction jacket 100. The jacket 100, in some embodiments, protects the cable 10 from mechanical, moisture and/or chemical issues, and may additionally provide flame resistance and/or protection against sunlight.

In embodiments herein, the jacket 100 comprises a low-friction polymer blend. The low-friction polymer blend comprises a fluorine-free resin, and further comprises an acrylic polymer, a polyethylene polymer, or combinations thereof. Any of the low-friction polymer blends described in the preceding section (i.e., “Low-Friction Polymer Blend and Method of Making”), or elsewhere in this disclosure, may be employed as the low-friction polymer blend in the jacket 100 of a cable 10 described herein.

Any fluorine-free resin not inconsistent with the technical objectives of this disclosure may be employed in the low-friction polymer blend of a cable 10 described herein. The fluorine-free resin will preferably have thermal, mechanical, and electrical properties suitable for use in a cable jacket 100 or a low-friction conduit. In some embodiments, the fluorine-free resin comprises one or more polyamide resins, polyolefin resins, polyvinyl chloride resins, or combinations thereof. Any polyamide resin, polyolefin resin, and/or polyvinyl chloride resin described elsewhere in this disclosure may be employed in the low-friction polymer blend of a cable 10 described herein, such as, for example, polyamide 6, polyamide 66, polyamide 12, or combinations thereof. In a preferred embodiment, the fluorine-free resin is polyamide 6.

Any acrylic polymer not inconsistent with the technical objectives of this disclosure may be employed in the jacket 100 of a cable 10 herein. The acrylic polymer will preferably reduce the frictional characteristics of the final product. Any acrylic polymers described elsewhere in this disclosure may be employed in a cable 10 herein, including, for example, polyacrylic and polymethacrylic materials, such as polymethyl acrylate (PMA) and polymethyl methacrylate (PMMA). In some embodiments, the acrylic polymer is a cross-linked acrylic polymer. In a preferred embodiment, the acrylic polymer is a cross-linked polymethyl acrylate (X-PMA).

The acrylic polymer in the jacket 100 of a cable 10 as disclosed herein may have any properties and/or characteristics described elsewhere in this disclosure, including the previously disclosed average particle sizes and size ranges, decomposition temperatures, and/or heating loss properties. In some embodiments, the low-friction polymer blend of the jacket 100 comprises up to about 15%, 14%, 13%, 12%, 11%, 10%, 9%, 8%, 7%, 6%, 5%, 4%, 3%, 2%, or 1% w/w of the acrylic polymer. In some embodiments, the polymer blend in the jacket 100 comprises at least about 0.05%, 0.1%, 0.2%, 0.3%, 0.4%, 0.5%, 0.75%, 1.0%, 1.25%, 1.5%, 1.75%, or 2.0% w/w of the acrylic polymer. In some embodiments, the polymer blend comprises about 0.1-15%, 0.1-10%, 0.1-9%, 0.1-8%, 0.1-7%, 0.1-6%, 0.1-5%, 0.1-4%, 0.1-3%, 0.1-2%, 0.1-1%, 0.5-15%, 0.5-10%, 0.5-9%, 0.5-8%, 0.5-7%, 0.5-6%, 0.5-5%, 0.5-4%, 0.5-3%, 0.5-2%, 0.5-1%, 1-15%, 1-10%, 1-9%, 1-8%, 1-7%, 1-6%, 1-5%, 1-4%, 1-3%, or 1-2% w/w of the acrylic polymer.

Any polyethylene polymer not inconsistent with the technical objects of this disclosure may be employed in the low-friction polymer blend of the jacket 100, including the polyethylene polymers described elsewhere in this disclosure. The polyethylene will preferably reduce the frictional characteristics of the final product. Examples thereof include ultra-high molecular weight polyethylene (UHMWPE), high-density polyethylene (HDPE), medium-density polyethylene (MDPE), low-density polyethylene (LDPE), linear low-density polyethylene (L-LDPE), and very low-density polyethylene (V-LDPE). In a preferred embodiment, the low-friction blend of the jacket 100 contains UHMWPE.

In some embodiments, the low-friction polymer blend of the jacket 100 may also optionally comprise a fluoropolymer, such as any of the fluoropolymers described elsewhere in this disclosure. In some embodiments, the low-friction polymer blend of the jacket 100 comprises up to about 80%, 75%, 70%, 65%, 60%, 55%, 50%, 45%, 40%, 35%, 30%, 25%, 20%, 19%, 18%, 17%, 16%, 15%, 14%, 13%, 12%, 11%, 10%, 9%, 8%, 7%, 6%, 5%, 4%, 3%, 2%, 1%, or 0.5% w/w fluoropolymer. It is to be understood that the presence or addition of a fluoropolymer in the low-friction polymer blend of the jacket 100 is optional, and the polymer blend may comprise 0% fluoropolymer, or may comprise an insignificant amount of fluoropolymer. The polymer blend may also contain additional optional components as appropriate, including any of the additional components disclosed elsewhere in this disclosure.

When the fluorine-free resin in the low-friction blend of the jacket 100 is a polyamide resin, the jacket 100 has, in some embodiments, a coefficient of static friction on the surface of 0.32 or lower, 0.29 or lower, or 0.28 or lower. When the fluorine-free resin is a polyolefin resin, the jacket 100 may have a coefficient of static friction on the surface of 0.22 or lower, 0.20 or lower, or 0.19 or lower. When the fluorine-free resin is polyvinyl chloride resin, the jacket 100 may have a coefficient of static friction on the surface of 0.36 or lower, 0.34 or lower, or 0.32 or lower. The lower limit of the coefficient of static friction is preferably as low as possible, and may be 0.01. A jacket 100 having a coefficient of friction within the above ranges can exhibit improved smoothness. The coefficient of static friction is determined using a surface property tester on the jacket material and a stainless steel plate (1 cm²) serving as a friction element, in accordance with ASTM D1894-14 (2014).

The jacket 100 of a cable 10 described herein may have any thickness not inconsistent with the technical objectives herein. For instance, in some embodiments, the jacket 100 has a thickness of about at least 30 μm, at least 40 μm, or at least 50 μm.

The cable 10 may comprise a conductor 300, such as a wire or plurality of wires. The conductor 300 may be formed of any material which exhibits good conductivity. For instance, in some embodiments, the wire comprises copper, copper alloys, copper-clad aluminum, aluminum, silver, gold, zinc-plated iron, or combinations thereof. Some embodiments of the cable 10 comprise one or more twisted pairs of wires.

In another aspect, methods of manufacturing a cable 10 are provided. In one embodiment, a method of manufacturing a cable 10 comprises the step of extruding a polymer melt to form a jacket 100 of the cable 10. In some embodiments, the polymer melt comprises a fluorine-free resin, and further comprises an acrylic polymer, a polyethylene polymer, or combinations thereof. The low-friction polymer blends disclosed elsewhere in this disclosure, including in the preceding sections, may be employed as the polymer melt to be extruded in a manufacturing method herein.

Any fluorine-free resin not inconsistent with the technical objectives of this disclosure may be employed in the polymer melt that is extruded in a method herein. The fluorine-free resin will preferably have thermal, mechanical, and electrical properties suitable for use in a cable jacket 100 or a low-friction conduit. In some embodiments, the fluorine-free resin comprises one or more polyamide resins, polyolefin resins, polyvinyl chloride resins, or combinations thereof. Any polyamide resin, polyolefin resin, and/or polyvinyl chloride resin described elsewhere in this disclosure may be employed, including polyamide 6, polyamide 66, polyamide 12, or combinations thereof. In a preferred embodiment, the fluorine-free resin is polyamide 6.

Any acrylic polymer not inconsistent with the technical objectives of this disclosure may be employed in the polymer melt that is extruded in a method herein, including any acrylic polymers described elsewhere in this disclosure. The acrylic polymer will preferably reduce the frictional characteristics of the final product. Examples thereof include polyacrylic and polymethacrylic materials, such as polymethyl acrylate (PMA) and polymethyl methacrylate. In some embodiments, the acrylic polymer is a cross-linked acrylic polymer. In a preferred embodiment, the acrylic polymer is a cross-linked polymethyl acrylate (x-PMA). The acrylic polymer may have any properties and/or characteristics described elsewhere in this disclosure, including all previously disclosed average particle sizes and size ranges, decomposition temperatures, and/or heating loss properties. In some embodiments, a polymer melt described herein comprises up to about 15%, up to 14%, up to 13%, up to 12%, up to 11%, up to 10%, up to 9%, up to 8%, up to 7%, up to 6%, up to 5%, up to 4%, up to 3%, up to 2%, or up to 1% w/w of the acrylic polymer. In some embodiments, the polymer melt comprises at least about 0.05%, 0.1%, 0.2%, 0.3%, 0.4%, 0.5%, 0.75%, 1.0%, 1.25%, 1.5%, 1.75%, or 2.0% w/w of the acrylic polymer. In some embodiments, the polymer melt comprises about 0.1-15%, 0.1-10%, 0.1-9%, 0.1-8%, 0.1-7%, 0.1-6%, 0.1-5%, 0.1-4%, 0.1-3%, 0.1-2%, 0.1-1%, 0.5-15%, 0.5-10%, 0.5-9%, 0.5-8%, 0.5-7%, 0.5-6%, 0.5-5%, 0.5-4%, 0.5-3%, 0.5-2%, 0.5-1%, 1-15%, 1-10%, 1-9%, 1-8%, 1-7%, 1-6%, 1-5%, 1-4%, 1-3%, or 1-2% w/w of the acrylic polymer.

Any polyethylene polymer not inconsistent with the technical objectives of this disclosure may be employed in the polymer melt that is extruded in a method herein. The polyethylene will preferably reduce the frictional characteristics of the final product. For instance, any of the polyethylene polymers described elsewhere in this disclosure may be employed, including ultra-high molecular weight polyethylene (UHMWPE), high-density polyethylene (HDPE), medium-density polyethylene (MDPE), low-density polyethylene (LDPE), linear low-density polyethylene (L-LDPE), and very low-density polyethylene (V-LDPE). In a preferred embodiment, the polyethylene polymer employed in the polymer melt that is extruded in a method herein is or contains UHMWPE.

In some embodiments, the polymer melt extruded in a method herein may also optionally comprise a fluoropolymer. Any of the fluoropolymers described elsewhere in this disclosure may be employed. In some embodiments, the polymer melt comprises up to about 80%, 75%, 70%, 65%, 60%, 55%, 50%, 45%, 40%, 35%, 30%, 25%, 20%, 19%, 18%, 17%, 16%, 15%, 14%, 13%, 12%, 11%, 10%, 9%, 8%, 7%, 6%, 5%, 4%, 3%, 2%, 1%, or 0.5% w/w fluoropolymer. It is to be understood that the presence or addition of a fluoropolymer in the polymer melt is optional, and the polymer melt may comprise 0% fluoropolymer, or may comprise an insignificant amount of fluoropolymer.

The polymer melt may also contain additional optional components as appropriate. Any of the additional components disclosed elsewhere in this disclosure may be employed.

In another aspect, a method of manufacturing a cable 10 comprises the steps of: (1) mixing a masterbatch polymer blend (“masterbatch”) with an acrylic polymer so as to form a polymer melt having the desired concentration of acrylic polymer; and (2) extruding the polymer melt to form a jacket 100 of the cable 10.

In some embodiments, the step (1) of mixing the masterbatch with an acrylic polymer comprises diluting the masterbatch in or with the acrylic polymer so as to achieve a diluted composition (i.e., a polymer melt) having the desired concentration of acrylic polymer. In some embodiments, the masterbatch is diluted with the acrylic polymer to form a polymer melt having up to about 20%, 19%, 18%, 17%, 16%, 15%, 14%, 13%, 12%, 11%, or 10% w/w of the acrylic polymer. In some embodiments, the masterbatch is diluted to the point at which the acrylic polymer concentration is about 0.1%-20%, 0.1%-19%, 0.1-18%, 0.1-17%, 0.1-16%, 0.1-15%, 0.1-14%, 0.1-13%, 0.1-12%, 0.1-11%, or 0.1-10% w/w. In further embodiments, the masterbatch is diluted until the acrylic polymer concentration is at least about 0.5%, 1.0%, 1.5%, 2.0%, or 2.5%.

The masterbatch used in the method of manufacturing a cable 10 described herein may have any of the compositions, characteristics, and/or properties described elsewhere in this disclosure. For instance, in some embodiments, the masterbatch comprises a fluorine-free resin and additionally comprises an acrylic polymer, a polyethylene polymer, or combinations thereof. The masterbatch may comprise any fluorine-free resin, acrylic polymer, and/or polyethylene polymer disclosed elsewhere in this disclosure. The additional acrylic polymer added to the masterbatch (to dilute the masterbatch with the additional acrylic polymer) may be any acrylic polymer described elsewhere in this disclosure. In some embodiments, the acrylic polymer is polymethyl acrylate (PMA). In some embodiments, the acrylic polymer is cross-linked polymethyl acrylate (X-PMA). Any masterbatch polymer blend disclosed elsewhere in this disclosure, including in the section “Masterbatch and Method of Making” hereinabove, may be employed as the masterbatch used in the methods of manufacturing a cable 10 described herein. The masterbatch may contain an acrylic polymer, polyethylene polymer, or combination thereof in any of the amounts and concentrations disclosed in the preceding section or elsewhere in this disclosure. In a preferred embodiment, the acrylic polymer, polyethylene, or combination thereof is present at about 20% w/w to about 80% w/w in the masterbatch.

Additionally, the masterbatch may contain additional optional components as appropriate, such as any of the additional components described elsewhere in this disclosure. The masterbatch may be produced by mixing the fluorine-free resin and the acrylic polymer and/or polyethylene polymer together, optionally with any additional components as appropriate. Mixing may be performed using a device such as a single- or twin-screw extruder, an open roll mill, a kneader, or a Banbury mixer.

The masterbatch may be in any form not inconsistent with the technical objectives herein, such as, for example, a powder, granules, or pellets. In some embodiments, the masterbatch is in the form of pellets obtained by melt kneading. The temperature for the melt kneading, in some embodiments, higher than the melting point of the fluorine-free resin by at least 5° C.

In the step (2), the polymer melt is extruded to form a jacket 100 of a cable 10. In some embodiments, the polymer melt is extruded onto a core wire, so that the jacket 100 is formed on the core wire. Examples of the core wire include the same as those usable for the cables 10 of the present disclosure, as discussed elsewhere in this disclosure.

The melt extrusion may be performed using a known extruder, such as a single- or twin-screw extruder. In embodiments herein, the temperature for the melt extrusion is not lower than the melting point of the fluorine-free resin and not higher than 320° C., 310° C. or 300° C.

An exemplary device usable in the method for producing a cable 10 of the present disclosure may include a reel configured to supply a core wire to an extrusion head, a tank for an acrylic polymer, a tank for a masterbatch, a cooling box configured to cool the outer surface of a mixture of the acrylic polymer and the masterbatch in a molten or semi-solid state on the core wire, and a reel configured to take up the resulting cable 10.

Some embodiments of the above production methods can be used to produce the aforementioned cables 10 of the present disclosure.

A cable conduit is also provided herein, comprising a hollow tube designed to accommodate one or more electric wires. The one or more electric wires may be in the form of a cable 10, including the cables 10 described hereinabove in this disclosure. The hollow tube may be rigid, semi-rigid or flexible, and may be metallic or non-metallic. In embodiments herein, the cable conduit is designed such that one or more electric wires or one or more cables 10 can be pulled through the hollow tube.

### Working Example 1: Pull Force Testing Protocol

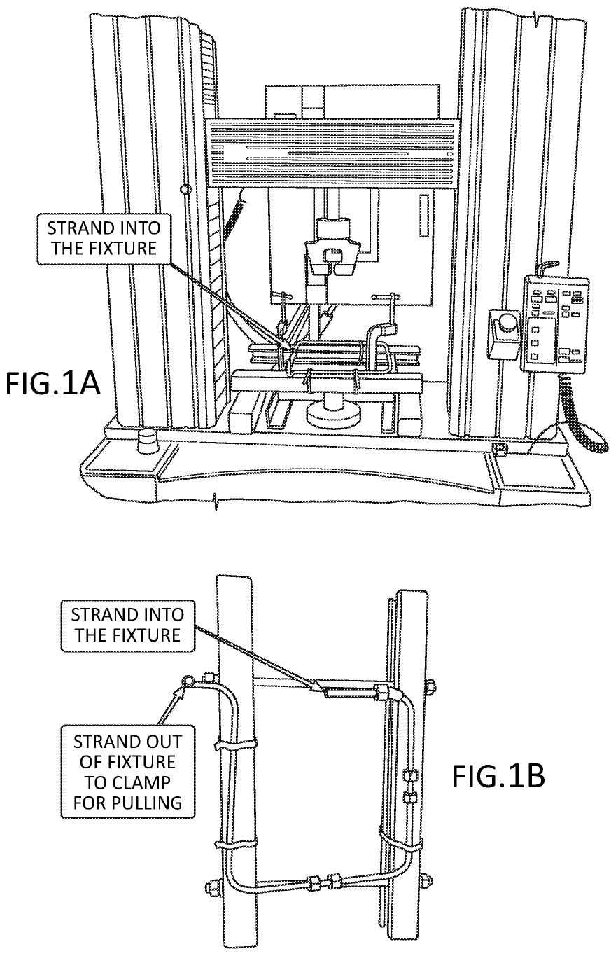

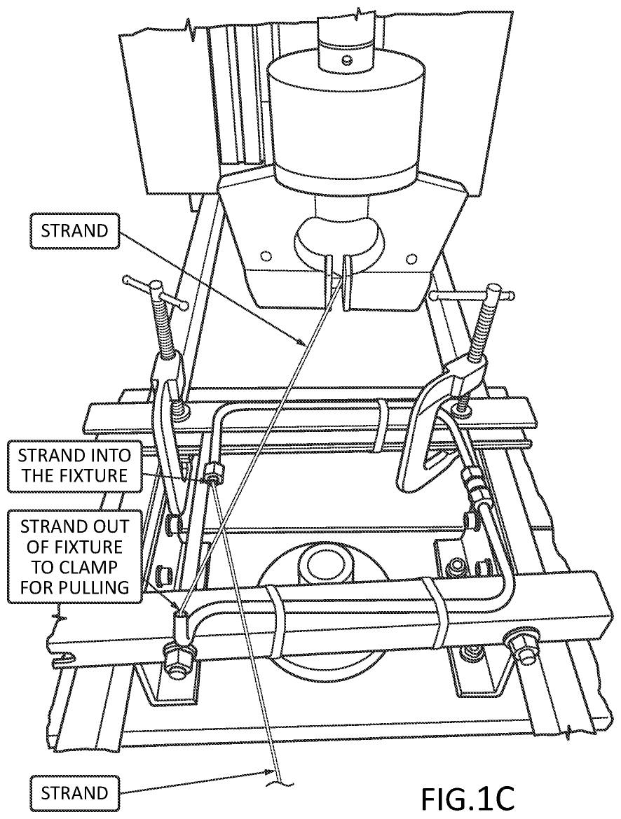

A testing protocol was developed to measure the force required to pull strands of the polymer blend through a clamp. This was used to measure the relative required pull force of different embodiments of the polymer blend and comparative examples. Testing and screening of formulations was done on an Instron 5582 with Bluehill software (Illinois Tool Works Inc. (DBA Instron, Norwood, Massachusetts)) and a custom-made testing fixture. The fixture was made of ¼″ stainless steel tubing with five 90° bends to increase the forces necessary to pull the test strand through the fixture. Tests were conducted at 400 mm min⁻¹ pull speed for a distance of approximately 500 mm. Multiple strands were used to generate measurable forces when necessary. Five pulls were performed to calculate an average and standard deviation. Strands were made by extruding the desired formulation through a twin screw extruder and pulling through a water bath with a “pelletizer” that has the pellet blade removed. This allowed the strand to be pulled from the extruder at a constant rate, helping maintain a consistent diameter. Experience suggested strands must be extruded under same conditions and pulled with the fixture in the same position to reduce variation. FIG. 1 shows photographs of the testing apparatus employed. Unless stated otherwise, all measurements of pull force in this description refer to pull force as it would be measured by the protocol described here.

### Working Example 2: Process of Producing a Polymer Blend

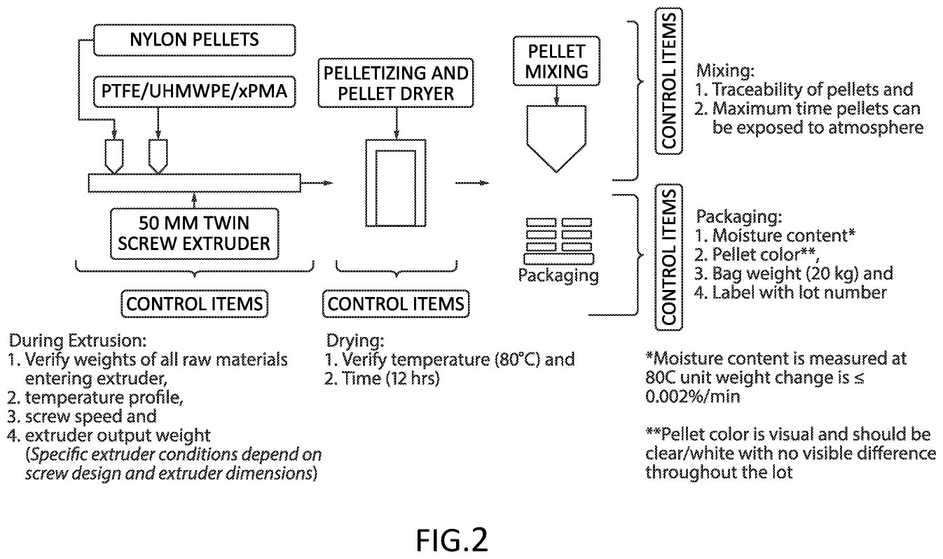

FIG. 2 shows a scheme that was employed to make pellets of an embodiment of the polymer blend. Pellets of Nylon (PA-6) were fed into a Liestritz ZSE 18 HPE 50 mm twin screw extruder (Leistritz Extrusionstechnik GmbH, Nuremberg, Germany). Pellets of at least one of the following were fed into the extruder downstream of the Nylon: PTFE, ultra-high molecular weight PE, and x-PMA. During extrusion care was taken to verify weights of all raw materials entering extruder, to control the temperature profile, to control the screw speed, and to control the extruder weight output. The extruded blend was pelletized and processed in a Conair D50 pellet dryer (Conair Group, Cranberry PA). Temperature was controlled at 80° C. during drying for 12 hours. The dried pellets were mixed under conditions of controlled exposure to air. Pellets were packed under conditions of controlled moisture, and pellet color was noted visually.

### Working Example 3: Performance of UHMWPE Blends

Experiments were conducted comparing the pull force requirements of polymer blends of PA-6 with ultra-high molecular weight PE and PTFE. Strands were made of polymer blends made according to Working Example 2, and tested according to Working Example 1. The UHMWPE was obtained commercially, and had a particle size of 30 μm. Comparative example contained only PA-6. The results are shown in Table 1 below, and in FIG. 3. All percentages w/w. Results of the pull tests are shown in MPa:

TABLE 1
Tested UHMWPE Blends

| Sample | Components | MPa | Std Dev |
|---|---|---|---|
| 1 | 100% PA6 | 5.66 | 0.49 |
| 2 | 1% PTFE/5% UHMWPE | 1.83 | 0.11 |
| 3 | 1.5% PTFE/4.5% UHMWPE | 1.20 | 0.05 |
| 4 | 2% PTFE/4% UHMWPE | 1.82 | 0.24 |
| 5 | 3% PTFE/3% UHMWPE | 1.08 | 0.10 |
| 6 | 4.5% PTFE/1.5% UHMWPE | 1.12 | 0.12 |

### Working Example 4: Performance of X-PMA Blends

Experiments were conducted comparing the pull force requirements of polymer blends of PA-6 with cross-linked PMA, with and without PTFE. Strands were made of polymer blends made according to Working Example 2, and tested according to Working Example 1. Various size grades of x-PMA were used. A comparative sample contained only PA-6. It was observed that as the average particle size increased past 4.5 μm and the percentage increased from 3 to 6, the appearance of the strand became flatter. This appears to be related to pressure surges in the extruder. Samples made at 6% of 8 μm x-PMA, 10 μm x-PMA, and 20 μm x-PMA were not pull tested because of the deformed strands.

The results are shown in Table 2 below. All percentages w/w. Particle sizes of x-PMA are shown in μm. Results of the pull tests are shown in MPa:

TABLE 2
Tested x-PMA Blends

| | | Pull | |
|---|---|---|---|
| Sample | | Force (MPa) | |
| No. | Sample Composition | Average | Std Dev |
| 1 | 100% PA6 | 5.66 | 0.49 |
| 2 | 1.5% x-PMA (4.8 μm) | 2.9 | 0.27 |
| 3 | 3% x-PMA (4.8 μm) | 2.51 | 0.31 |
| 4 | 3% x-PMA (4.8 μm) | 2.25 | 0.29 |
| 5 | 4.5% x-PMA (4.8 μm) | 2.22 | 0.5 |
| 6 | 6% x-PMA (4.8 μm) | 2.25 | 0.29 |
| 7 | 3% x-PMA (4.8 μm) + 3% PTFE | 3.83 | 0.55 |
| 8 | 3% x-PMA (1.3 μm) | 4.56 | 0.41 |
| 9 | 3% x-PMA (1.3 μm) + 3% PTFE | 3.62 | 0.19 |
| 10 | 3% x-PMA (2.6 μm) | 4.38 | 0.68 |
| 11 | 3% x-PMA (2.6 μm) + 3% PTFE | 2.58 | 0.51 |
| 12 | 3% x-PMA (8 μm) | 3.48 | 0.27 |
| 13 | 3% x-PMA (10 μm) | 4.25 | 0.18 |
| 14 | 3% x-PMA (20 μm) | 4.25 | 0.30 |

### Conclusion

It is to be understood that any given elements of the disclosed embodiments of the invention may be embodied in a single structure, a single step, a single substance, or the like. Similarly, a given element of the disclosed embodiment may be embodied in multiple structures, steps, substances, or the like. The foregoing description and accompanying drawings illustrate and describe certain processes, machines, manufactures, and compositions of matter, some of which embody the invention(s). Such descriptions or illustrations are not intended to limit the scope of what can be claimed, and are provided as aids in understanding the claims, enabling the making and use of what is claimed, and teaching the best mode of use of the invention(s). If this description and accompanying drawings are interpreted to disclose only a certain embodiment or embodiments, it shall not be construed to limit what can be claimed to that embodiment or embodiments. Any examples or embodiments of the invention described herein are not intended to indicate that what is claimed must be coextensive with such examples or embodiments. Where it is stated that the invention(s) or embodiments thereof achieve one or more objectives, it is not intended to limit what can be claimed to versions capable of achieving all such objectives. Any statements in this description criticizing the prior art are not intended to limit what is claimed to exclude any aspects of the prior art. Additionally, the disclosure shows and describes certain embodiments of the processes, machines, manufactures, compositions of matter, and other teachings disclosed, but it is to be understood that the teachings of the present disclosure are capable of use in various other combinations, modifications, and environments and is capable of changes or modifications within the scope of the teachings as expressed herein. Any section headings herein are provided only for consistency with the suggestions of 37 C.F.R. § 1.77 or otherwise to provide organizational queues. These headings shall not limit or characterize the invention(s) set forth herein.

1. (canceled)

2. A masterbatch polymer blend, comprising: 20-80% w/w of one or both of a polymethyl acrylate (PMA) and a polyethylene (PE); and a polyamide (PA).

3. The masterbatch polymer blend of claim 2, comprising 30-70% of the PMA.

4. The masterbatch polymer blend of claim 2, comprising 40-60% of the PMA.

5. A method of making a low-friction polymer blend, the method comprising: diluting the masterbatch polymer blend of claim 2 with additional PA, resulting in the low-friction polymer blend having up to about 10% w/w of the one or both of a polymethyl acrylate (PMA) and a polyethylene (PE).

6. (canceled)

7. A low-friction polymer blend that is the product of the method of claim 5.

8. A cable having a jacket, wherein the jacket comprises the low-friction polymer blend of claim 7.

9. (canceled)

10. (canceled)

11. A method of manufacturing a cable, comprising: diluting the masterbatch polymer blends of claim 2 with additional PA to form a polymer melt having up to about 10% w/w of the one or both of a polymethyl acrylate (PMA) and a polyethylene (PE); and extruding the polymer melt to form an outer jacket of a cable.

12. A cable that is the product of the method of claim 11.

13. The masterbatch polymer blend of claim 2, wherein the PMA is a cross-linked PMA (x-PMA).

14. The masterbatch polymer blend of claim 2, wherein the PA is polycaprolactam (PA-6).

15. The masterbatch polymer blend of claim 2, wherein the blend further comprises a fluoropolymer.

16. The masterbatch polymer blend of claim 2, wherein the blend comprises 0-5% w/w fluoropolymer.

17. (canceled)

18. (canceled)

19. (canceled)

20. (canceled)

21. (canceled)

22. The masterbatch polymer blend of claim 2, wherein the blend further comprises a fluoropolymer, and the fluoropolymer is polytetrafluoroethylene (PTFE).

23. The masterbatch polymer blend of claim 2, wherein the blend comprises from 0.1-10% w/w of the PMA.

24. (canceled)

25. (canceled)

26. The masterbatch polymer blend of claim 2, wherein the PMA has an average particle size of up to about 20 μm.

27. (canceled)

28. (canceled)

29. (canceled)

30. (canceled)

31. (canceled)

32. (canceled)

33. (canceled)

34. (canceled)

35. (canceled)

36. (canceled)

37. The masterbatch polymer blend of claim 2, wherein the PMA is an x-PMA, and has a decomposition temperature of 230-260° C.

38. (canceled)

39. The masterbatch polymer blend of claim 2, wherein the PMA is an x-PMA, and has a heating loss of less than about 0.5%.

40. (canceled)

41. The masterbatch polymer blend of claim 2, wherein the polyethylene is ultra-high molecular weight polyethylene (UHMWPE).

42. The masterbatch polymer blend of claim 2, wherein the polyethylene is ultra-high molecular weight polyethylene (UHMWPE) having a particle size of 20-40 μm, 25-35 μm, or about 30 μm.

43. The masterbatch polymer blend of claim 2, wherein the polyethylene is ultra-high molecular weight polyethylene (UHMWPE), and comprising PTFE.

44. The masterbatch polymer blend of claim 2, wherein the polyethylene is ultra-high molecular weight polyethylene (UHMWPE), and comprising 2-4% w/w PTFE and 2-4% w/w UHMWPE.

45. The masterbatch polymer blend of claim 2, wherein the polyethylene is ultra-high molecular weight polyethylene (UHMWPE), and comprising about 3% w/w PTFE and about 3% w/w UHMWPE.
